(19) United States
(12) Patent Application Publication
(10) Pub. No.: US 2010/0090832 A1
(43) Pub. Date: Apr. 15, 2010

(54) METHOD OF PROTECTING A RADIO FREQUENCY IDENTIFICATION INLAY

(76) Inventors: Francois Bozet, Mont-St-Hilaire (CA); Stephane Rousseau, Laval (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 12/160,721

(22) PCT Filed: Apr. 25, 2007
(86) PCT No.: PCT/CA07/00690

§ 371 Date: Mar. 4, 2009

(51) Int. Cl. G08B 13/14

(52) U.S. Cl. 340/572.8

(57) ABSTRACT

The present invention provides a container blank having at least one joint formed by overlapping panels. Between the panels is located at least one RFID inlay and at least one adhesive layer for joining the panels to each other.

### FIELD OF THE INVENTION

The invention relates to radio frequency identification technology used in packaging media. In particular, the invention relates to a method of protecting a radio frequency identification inlay used in a packaging media.

### BACKGROUND OF THE INVENTION

Radio frequency identification (RFID) technology is a wireless technology that uses electronic tags for storing data. A typical RFID system will include a transponder, an antenna and a transceiver also referred to as a reader. The transponder, also known as inlay or tag, is itself comprised of an integrated circuit, commonly referred to as a chip, which is attached to an antenna. The integrated circuit-antenna assembly resides on a substrate typically made of polyethylene terephtalate, polyester, polypropylene or polycarbonate.

Generally, the RFID inlay will include data that is specific to the use of the particular inlay. Inlays may be passive, semi-passive or active which means that they may include their own power source (active) or alternatively may obtain power from an external source, for example from a radio frequency signal that interrogates the inlay (passive). Passive inlays require the use of an external power source, such as a base station or reader, in order for the information on the inlay to be read and transmitted, if required.

A typical use of RFID technology occurs in the retail business where RFID inlays are used on clothing for security purposes. Another use of RFID technology is in the shipping business. RFID inlays may be incorporated into containers for tracking and sorting the containers during shipment and storage.

There is a continual need to protect RFID inlays from any physical damage that may occur during shipment and storage of containers. A typical placement for an RFID inlay is on the external surface of a container. Usually such RFID inlays are attached to the container in the form of a label that includes a paper backing and the RFID system applied to the paper backing. When an RFID inlay is placed on the external surface of a package it is exposed and therefore can be subjected to damage and undue stress that can affect the performance of the inlay. In particular, inlays may be damaged by scratching, puncturing of the container, compression, stretching and/or buckling of part of or all of the container. Placing the RFID inlay on the external surface of a package also means exposing it to water and other liquids, which are known to negatively affect the inlay performance.

RFID inlays that are provided in the form of labels, i.e. having a paper backing attached, can also be expensive since the cost of the paper backing must be added to the cost of the inlay. Since, for example in the transportation industry, an RFD inlay is attached to each package to be shipped the expense of each inlay label will increase the overall cost considerably. Moreover, to compensate for the increased probability of the inlay being subjected to damage or harmful environmental conditions associated with labels, it has been common practice to print barcodes, essentially a redundant addition that acts as a safety net should the inlay be rendered non functional, on labels containing RFID inlays, further adding to the cost of this approach.

Usually the performance of an RFID inlay is commonly measured as read rate, i.e. number of inlays read/number of inlays queried. Sometimes, as when inlays are moving with respect to a reader, the read rate may be defined as the number of times per second an inlay is read while it was within the RF field. While it is desired that the RFID inlay be protected while in use, it is also important that the utility of the inlay, i.e. read rate, not be affected. RFID inlays have a high level of sensitivity and therefore it is important that the inlay not be affected not only by external factors but also by such things as the material of the container on which it is being used.

### SUMMARY OF THE INVENTION

The present invention provides an RFID enabled container blank comprising a plurality of panels configured to form a container, at least one joint formed from at least two overlapping panels and at least one RFID inlay located within the joint on the surface of at least one of the overlapping panels such that the RFID inlay is positioned between the overlapping panels. The container blank also includes an adhesive layer, for adhering the overlapping panels of the at least one joint, located between the overlapping panels and on at least one surface of the RFID inlay.

In another aspect, the present invention provides a method of manufacturing an RFID enabled packaging media blank. The method comprises the steps of (i) forming a flat packaging media blank having a plurality of panels configured to form a packaging media when the blank is assembled; (ii) attaching an RFID inlay to at least one of the panels; (iii) applying an adhesive layer to at least one of the panel comprising the RFID inlay and an adjacent panel with which the at least one panel is operable to form a joint with; and (iv) forming a joint with the panel comprising the RFID inlay and the at least one other panel, wherein the RFID inlay is located between the panels adjacent the adhesive layer and the adhesive layer substantially covers the RFID inlay.

In another aspect the present invention provides a method for installing and verifying an RFID inlay in a packaging media comprising the steps of (i) providing at least one packaging media blank having a plurality of panels configured to form a packing media when the blank is assembled; (ii) providing at least one RFID inlay at a position operable to allow placement of the RFID inlay on at least one of the plurality of panels; (iii) confirming the operability of the RFID inlay; (iv) applying the RFID inlay to at least one of the plurality of panels; (v) applying adhesive to the surface of the RFID inlay; (vi) forming a joint between the panel to which the RFID inlay is attached and an adjacent panel in order to form a partially assembled packaging media; and (vii) confirming the operability of the RFID inlay. The method may also include the step of removing the packaging media if the confirmation step of the operability of the RFID inlay indicates a non-operable inlay.

The present invention further provides a packaging media formed from the blank described herein.

### BRIEF DESCRIPTION OF THE DRAWINGS

The present invention will now be described in further detail with reference to the following figures:

FIG. 1 is a plan view of a container blank according to one embodiment of the present invention, having an RFID inlay located within the blank;

FIG. 2a is a cross sectional view of a portion of a corrugated container blank showing the portion of the joint containing the RFID inlay;

FIG. 2b is a cross sectional view of a portion of a folding boxboard, or other media, showing the portion of the joint containing the RFID inlay;

FIG. 3a is a cross sectional view of an alternative embodiment of a portion of a corrugated container blank showing the portion of the joint containing the RFID inlay;

FIG. 3b is a cross sectional view of an alternative embodiment of a portion of a folding boxboard, or other media, showing the portion of the joint containing the RFID inlay;

FIG. 4 is a perspective view of the container blank of FIG. 1 prior to the container joint being formed;

FIG. 5 is a perspective view of a container formed from the container blank of FIG. 4;

FIG. 6 is a plan view of an envelope blank showing the positioning of an RFID inlay within a joint of the blank according to the present invention;

FIG. 7 is a plan view of an envelope formed from the blank of FIG. 6 with a cut away portion illustrating the position of the RFID inlay;

FIGS. 8a and 8b are charts that show the analysis of means of read rates by tag type for glued tags and for non glued tags on containers;

FIG. 9 is a chart that shows the variability for dry glue read rates on a container formed according to the present invention;

FIG. 10 is a chart that shows the variability for wet glue read rates on a container formed according to the present invention;

FIGS. 11a and 11b are charts that show the variability for Top-To-Bottom compression strength and the analysis of means of Top-To-Bottom compression strength by tag type in containers formed according to the present invention;

FIGS. 12a and 12b are charts that show the variability for encode % and the variability for verify runs of containers formed according to the present invention at 40 and 80 fpm; and

FIGS. 13a-c are charts that show the variability for encode, lock & verify runs for a container formed according to the present invention at 80 fpm.

### DETAILED DESCRIPTION OF THE PREFERRED EMBODIMENTS

The present invention provides an RFID enabled packaging media that utilises the structure of the packaging media to protect an RFID inlay from environmental factors such as high temperature, high humidity and high vibration, and which have been shown to affect its performance. The present invention further provides a method for making the RFID enabled packaging media. It will be understood that the terms “RFID inlay”, “RFID transponder” and “RFID tag” may be used interchangeably herein.

To-date it has generally been thought that the RFID inlay positioning must avoid contact with water or water-based products such as adhesives, however, the present invention has shown that adhesives, described herein, including but not limited to coldset, water-based formulations, can be made compatible with RFID inlays inserted within packaging structures. It has been found, and shown herein, that the use of an adhesive covering the RFID inlay located within a joint of a packaging media does not impact the function nor the physical integrity of the RFID inlay and further protects the RFID inlay in the packaging media when the packaging media is subjected to damage and undue stress. In particular, the use of a water-based adhesive in protecting the RFID inlay is described in the present invention.

The packaging media described herein may be any packaging media that includes a joint within its assembled form within which an RFID inlay may be placed. For example, the packaging media may be, but is not limited to, corrugated containerboard packaging, folding boxboard packaging, envelopes and flexible packaging media. It will be understood from the description provided herein that the adhesive used to form the remaining non-RFID containing joints on the final assembled packaging media, i.e. box or envelope, is the type of adhesive that is generally used in the art however, the adhesive used in the joint where the RFID inlay is located is as per the adhesive layer described herein. It will be understood that the standard method for assembling such packaging material has been amended in the present invention to incorporate the use of an RFID inlay with the adhesive layer described herein in order to provide a packaging media that includes an RFID inlay, the function and physically integrity of which is not impacted by its placement in the packaging media.

Corrugated containerboard is used as a packaging media to form boxes for packaging/storing and transporting goods. Corrugated containers generally include at least two fibrous layers that include a fluted layer between them.

Folding boxboard is also referred to in the art as folding cartons and can include, but is not limited to, the types of cardboard packaging that is used to make cereal boxes. Envelopes are well known and are usually formed from folding carton or paper.

Flexible packaging is made from films, for example a single composition or laminates of multiple compositions, and may also be laminated with a metal film, for example in the manufacturing of potato chip packaging. Examples of the films that may be used include, but are not limited to, polyester, polyethylene, polypropylene and poly lactic acid.

It will be understood from the above, and the description hereafter, that the packaging media described herein all contain at least one joint when in their assembled format. In the present invention, during assembly of each of theses packaging media an RFID inlay is placed at the position at which the joint will be formed so that the final assembled packaging media includes an RFID inlay within at least one joint. It will also be understood by a person skilled in the art that the packaging media described herein, in their unassembled form, generally include a series of panels and/or flaps that are folded and interconnected during assembly to form the final assembled packaging media.

In one embodiment the present invention provides an RFID enabled packaging media comprising a plurality of panels configured to form the assembled packaging media. It will be understood that the use of the term “panels” is not meant to be limiting and refers to panels and flaps that may be located on a packaging media. The packaging media includes at least one joint formed from at least two overlapping panels and at least one RFID inlay located within the joint on at least one surface of the overlapping panels such that the RFID inlay is positioned between the overlapping panels. It will be understood that the term RFID inlay used herein refers to a unit that includes a RF chip and antenna. The packaging media also includes an adhesive layer, which secures the overlapping panels of the at least one joint to each other. The adhesive layer is located between the overlapping panels and on at least one surface of the RFID inlay.

In an alternative embodiment, the present invention provides a packaging media formed from the blank described herein.

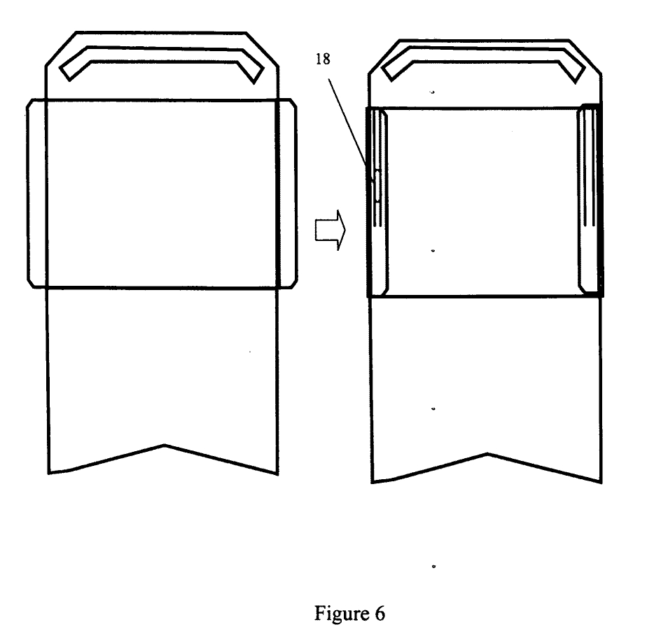

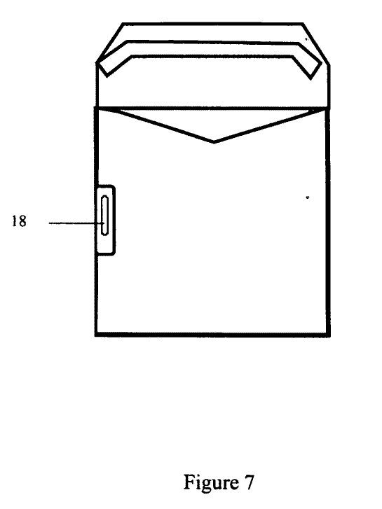

The protection of the RFID inlay is achieved by attaching it to the surface of one of the panels/flaps that forms the joint in the packaging media. It will be understood that the joint is defined as an overlapping area which is glued together before the packaging media is assembled. As an example, in the case of an envelope, the joint may be located along the ends of the formed envelope, as seen in FIGS. 6 and 7.

The positioning of the RFID inlay takes place prior to the ensuing gluing of the joint. Once the panels/flaps have been glued and folded upon each other, the RFID inlay is thus sandwiched between the two using an adhesive, which effectively seals the inlay from adverse environmental conditions, as described further below. Any remaining joints within the packaging media are adhered using traditional adhesives that are known and used in the art.

From the above description it will be understood that the joint in the packaging media is formed during manufacturing of the packaging media and prior to the final assembly of the packaging media, for example in the case of a packaging box, the joint may be formed in a container blank but the final packaging media, i.e. box or envelope, may not be formed until its use is required. This method ensures that the RFID inlay is securely held between the layers of the blank and will not be tampered or interfered with when the final packaging is assembled.

The adhesive layer used in the packaging media joint may be selected from a coldset adhesive, a non-destructive hotmelt adhesive and a starch-based additive. It will be understood that the use of the term “non-destructive” when used in conjunction with hotmelt adhesive, means that the hotmelt adhesive may be applied at a temperature that is within the operational range of the RFID inlays. It will also be understood that the adhesive used herein must be compatible with both the packaging media with which it is to be used and also with the RFID inlay.

Coldset adhesives are commonly referred to as water-based adhesives and do not require the use of heat to set and impart the adhesive properties to the surfaces to which they are applied. Coldset adhesives may be applied at room temperature. Examples of formulations of coldset adhesives that may be used include, but are not limited to, polyvinyl acetate (polymer and copolymer) vinyl acetate ethylene (copolymer) and vinyl acetate acrylate (copolymer).

Hotmelt adhesives are, as indicated in the name, applied hot, but will still dry at room temperature and usually under pressure. Examples of formulations of hotmelt adhesives that may be used include, but are not limited to, ethylene vinyl acetate (copolymer) and styrene (rubber copolymer).

Starch-based additives may also be used and are widely known in the art.

The adhesive used in the present invention is preferably a coldset adhesive. The coldset adhesive may be, but is not limited to, water-based emulsions of polyvinyl acetate, polyurethane, caseine, starch, latex and acrylic polymers and copolymers. Examples of formulations, known to persons skilled in the art, that may be used include those used in the manufacturing and sealing of containers. Modifications to such formulations may need to be made to alter certain critical adhesive properties such as tackiness in order to preserve the container's physical characteristics in the presence of an RFID inlay within its structure.

It will be understood that the packaging media may include more than one joint and therefore the packaging media may also include more than one RFID inlay. Each inlay may carry different information from the other inlays located on the same packaging media. It is also understood that the packaging media may include more than one type of adhesive, as described above. For example, the packaging media panels without the RFID inlay may be glued using adhesives that are known and generally used in the art and are specific for the type of substrate being used, i.e. paper, paperboard or plastic.

The types of RFID inlays that may be used are known to persons skilled in the art. Such RFID inlays are generally characterised by their product class, as defined by EPC Global, by memory size of the integrated chip, by antenna size, by frequency range, by minimum read sensitivity and by temperature range. The selection of the appropriate RFID inlay to be used may depend on the end use of the product to which it is to be attached.

Examples of RFID inlays that may be used include, but are not limited to, UPM Raflatac, for example model number Rafsec® Dogbone 3000825 and Rafsec® Short Dipole 3000843, Omron® Wave and Avery Dennison AD-220 600081.

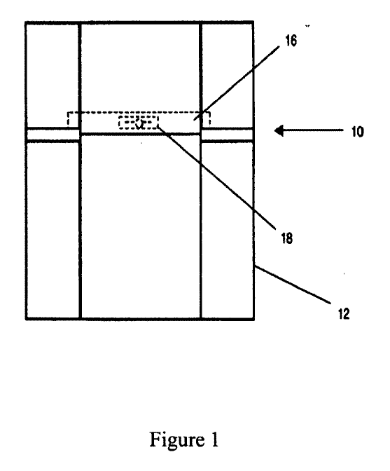

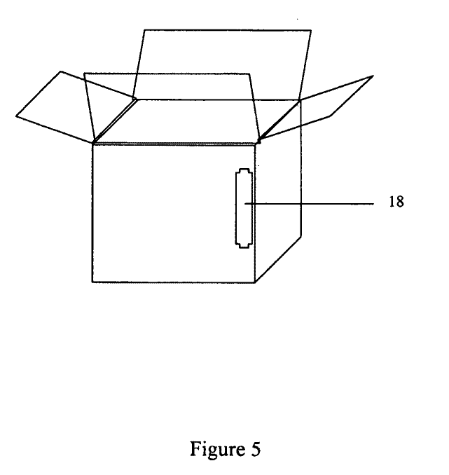

The present invention will now be described in detail with reference to the accompanying FIGS. 1 through 5 in which the RFID inlay is shown being positioned in a box blank that eventually forms a box, shown in FIG. 5. The container blank is shown at numeral 10 in the accompanying figures and it will be understood that in some of the figures the container blank 10 is shown in a partially formed configuration, i.e. without the formation of the joint within which the RFID inlay is received. However, it will be clear from the description below whether the blank is in a formed or partially formed configuration.

Turning to FIG. 1, the container blank 10 is shown having a plurality of panels 12. The panels 12 are of varying sizes and shape and are configured to provide a container when the blank is assembled into the final product by the end user. As will be understood by a person skilled in the art, the panels 12 may have various configurations depending on the final product desired, i.e. the shape and size of the container to be erected. Further, some of the panels are configured to overlap other panels in the erected configuration.

In order to clearly describe the present invention the following description will refer specifically to panels 12a and 12b that form a joint 16 within the container blank 10. However, it will be understood that the joint may be formed from panels other than the specific two exemplified panels. Further, the description may refer to the formation of the joint by adjacent panels. It will be understood that the term “adjacent” is used to refer to panels that are within a proximity of each other that allows them to overlap and form a joint and does not necessarily require the panels to be next to each other within the blank, although this configuration should not be excluded. FIG. 4 shows container blank 10 prior to the formation of joint 16. As can be seen in both FIGS. 4 and in particular in FIG. 1, panels 12a and 12b are configured to overlap when the container blank 10 is formed.

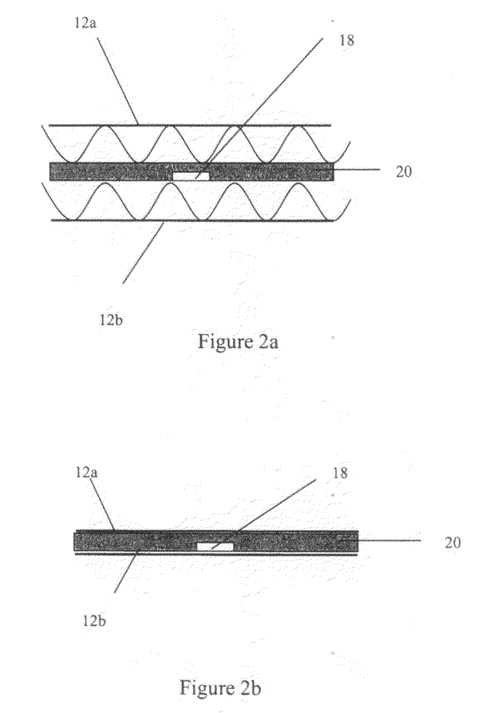

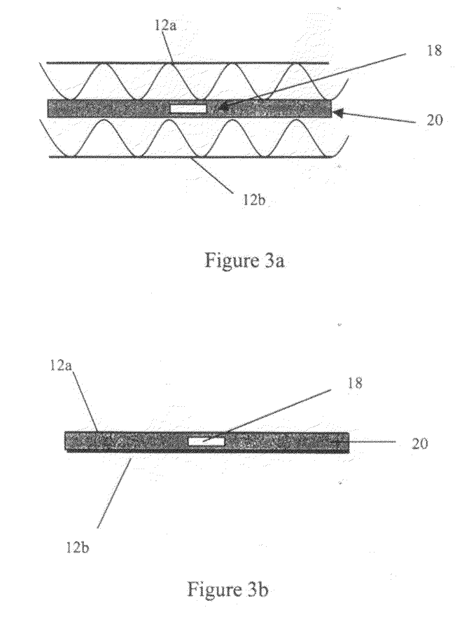

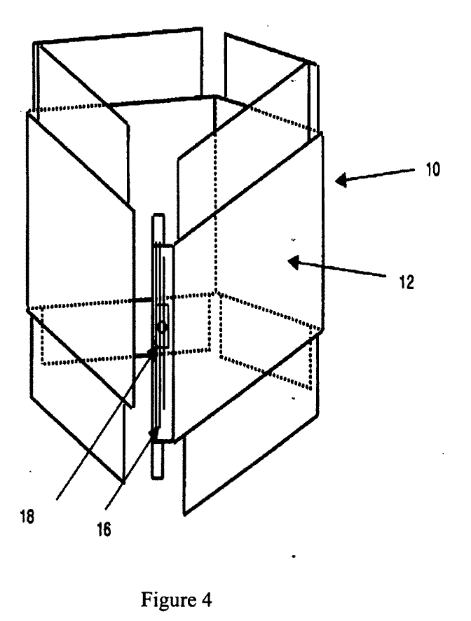

FIGS. 2a,b and 3a,b illustrate a close up cross sectional view of the joint 16 of the container blank 10. FIGS. 2a and 3a show a corrugated container blank joint whereas FIGS. 2b and 3b show a folding boxboard, or other media, blank joint. Each blank includes panels 12a and 12b described below. As can be seen, for example in FIG. 2, the panels 12a and 12b are configured to overlap and located between the panels 12a and 12b is RFID inlay 18. The inlay may be attached to one of the inner surfaces of the panels 12a and 12b. It will be understood that the term “inner surfaces” refers to the surfaces of panels 12a and 12b that face inwardly towards the other panel when the panels overlap. The attachment of the inlay 18 to one of the panels 12a or 12b will be discussed in further detail below.

In order to secure the joint 16 the panels 12a and 12b are attached using adhesive layer 20. Adhesive layer 20 is placed along the inner surface of at least one of the panels 12a, 12b and also across the surface of the inlay 18. The adhesive layer 20 may comprise any coldset adhesive, as described above. Alternatively, the joint 16 may Comprise a layer of adhesive 20 on the inner surface of both panels 12a, 12b, as seen in FIGS. 3a and 3b. The inlay 18 may then be secured between the panels 12a, 12b thereby being surrounded by the adhesive layers 20.

The adhesive layer 20 may be applied as a continuous layer over the surface of at least one panel and the inlay or the adhesive layer may be applied in elongated strips across the panel and inlay that overlap and form a solid continuous film when the panels are joined together. The adhesive layer may also be applied in one continuous strip that covers the RFID inlay.

The inlay 18 may be attached to the surface of one of the panels 12a, 12b using means known in the art. As discussed above, the inlay may include a substrate (e.g. PET), which typically has adhesive on the back. This adhesive, which may be different to the box adhesive, is used to position the inlay within the joint, prior to the application of the box adhesive on top of it. The adhesive is usually applied to the RFID inlay during manufacturing of the RFID inlay.

The present invention further provides a method of manufacturing an RFID enabled container blank. Initially a flat container blank is formed that includes a plurality of panels that are configured, i.e. sized and shaped, to form a container when the blank is erected. It will be understood, and as described above, that the panels may be varying sizes and shapes depending on the required final container. The use of the term “flat container blank” refers to the blank prior to a joint being formed. However, it should be understood that the formation of one joint does not imply that the container has been erected. In fact the container blank that may be shipped for use in a pre-assembled configuration includes a formed joint but is not in an assembled configuration.

Once the flat container blank is formed having a plurality of panels, an RFID inlay is attached to one surface of at least one of the panels. Methods of attaching the RFID inlay to the surface are known in the art and may be used in the method described herein. For example, the method may include the use of a pneumatic cylinder that blows the RFID label on which the inlay is located onto the linerboard surface.

The panel to which the RFID inlay is attached is one of the panels that is operable to form a joint in the blank. The RFID inlay is attached to the inside surface of the panel, i.e. the surface that will abut a second panel with which the joint is formed, so that it will be sandwiched between both panels when the joint is formed.

Once the RFID inlay is attached to one of the panels a layer of adhesive is placed on the inside surface of at least one of the panels which forms the joint. It will be understood that it may be placed on the surface of the panel that includes the RFID inlay, i.e. the adhesive layer will be placed on the surface of the panel and the surface of the inlay, or the adhesive layer may be placed on the surface of the other panel. However, it will be understood that once the joint is formed the adhesive layer will be placed between the panels and will substantially cover the RFID inlay surface, as illustrated in FIG. 2.

After the adhesive layer has been applied, the joint may be formed by overlapping the two panels and sandwiching the RFID inlay therebetween.

In a further embodiment of the invention a layer of adhesive may be applied to the inside surface of both panels that form the joint. Alternatively, the adhesive layer may be applied to the panel surface prior to the attachment of the inlay. Once the adhesive layer is applied and the inlay affixed to the adhesive layer a further layer of adhesive is added on the surface of the inlay in order to secure the joint.

The present invention further provides a method for forming a container blank having an RFID inlay that is embedded within the configuration of the blank that provides protection for the RFID inlay during shipment of the blanks. The blanks formed in the method may be shipped in their non-erected configuration which will save shipment costs, versus an erected configuration, and allows the end user to assembly the containers as required while ensuring that the RFID inlay will not be knocked or dislodged during shipment and storage.

The present invention further provides a method of manufacturing a container blank that has minimal affect on the RFID inlay while providing additional protection for the inlay within both the blank and the final container structure.

The present invention further provides a method for installing and verifying an RFID inlay in a packaging media. The method includes the initial steps of providing at least one packaging media blank, and preferably a plurality of packaging media blanks, each having a plurality of panels configured to form a packing media when the blank is assembled, for example a box or envelope. Examples of the blanks that may be provided are shown in FIGS. 1, 4 and 6.

The method also includes the step of providing at least one RFID inlay at a position which allows placement of the RFID inlay on at least one of the plurality of panels. The method may include the steps of providing a series of RFID inlays, each adjacent inlay to be placed on adjacent packaging media or more than one inlay to be placed on each packaging media, depending on the end use. The method then includes the step of confirming whether the RFID inlay is operable, i.e. readable. Once confirmation is received as to whether the RFID inlay is operable or not the RFID inlay is applied to at least one of the plurality of panels in the packaging media. If the RFID inlay is not readable the inlay will be skipped and the next readable inlay will be applied to the packaging media. As described above, the panel to which the RFID inlay is attached is one which is operable to form a joint in the packaging media blank with an adjacent panel.

Once the RFID inlay is attached to the panel of the packaging media, a layer of adhesive is applied to the surface of the RFID inlay. A joint may then be formed between the panel to which the RFID inlay is attached and an adjacent panel in order to form a partially assembled packaging media, the adhesive attaching the two panels together. Finally the operability of the RFID inlay is confirmed.

If the RFID inlay is shown as non-functioning then an indicator may be placed on the packaging media to which the non-functioning RFID inlay is attached so that the packaging media may be removed from further production/use. The indicator may be in the form of a UV ink marking. As an example, an ink jet marker may be linked to the RFID reader (transceiver), which signals it to mark non-readable boxes. A UV-light source is then used by the operators to identify the boxes that have to be removed from the line.

The method may also include the additional step(s) of removing the inlay or the packaging media, if the inlay is already affixed thereto, if the confirmation step of the operability of the RFID inlay indicates a non-operable inlay.

The amount of applied adhesive must be sufficient to cover the surface of the RFID inlay when the joint is formed. Alternatively, the amount of applied adhesive is sufficient to cover the surface of the RFID inlay prior to the formation of the joint.

The present invention provides a practical and economical method of applying RFID inlays in packaging material at the converting stage. As described herein, this invention includes several advantages not previously known in the art including: (i) an RFID inlay that is hidden and protected from physical damage, both from inside and outside the container within which it resides; (ii) use of an adhesive that serves to maintain the container's physical integrity and strength and protects the RFID inlay from water and liquids once it is dry; and (iii) a hidden inlay which offers several benefits including from the point of view of theft control. The present invention also provides a packaging media that includes an embedded RFID inlay within its structure that is not visible from the external surface of the packaging. Therefore, the RFID inlay cannot be clearly seen and cannot be tampered with by an external party.

The following examples provide additional information relating to the testing of packaging media including the RFID inlays in accordance with the present invention. Testing was undertaken to ascertain if the positioning of the adhesive across the RFID inlay would, as previously thought, inhibit the performance of the RFID inlay. It will be understood that these examples are not meant to be limiting to the scope of the present invention.

### Example 1

### Box Production

The boxes that include an RFID inlay according to the present invention and described in examples 2-4 were produced according to the following description.

The installation of the RFID inlays in the RFID-enabled corrugated boxes took place on a flexo-folder-gluer apparatus, referred to herein as an FFG. The RFID system that was installed on the FFG was composed of 2 sub-systems, namely the application module and the verification module. The applicator of the RFID inlays is located on the back (drive) side of the FFG, at the exit of the die-cut section and just prior to the gluer.

The principle of operation of the applicator is as follows, and as described above: a PLC receives signals from a photosensor (indicating the presence of a box) and from a encoder (whose output signal is proportional to the speed of the FFG) and controls the unwinding of the roll of RFID inlays (the web tension is controlled with a brake on the unwind stand) so as to assure that an inlay is always present on the applicator tamp when it has to begin its stroke towards the box surface (on the glue joint). The stroke of the tamp ends approx. 6 mm from the surface of the box, the inlay travelling this last distance unsupported as it is literally blown onto the cardboard using a pressurized air jet.

The verification step was performed at the exit of the FFG gravity outlet conveyor, which is just upstream of the piler's workstation. The verification is performed using antennas positioned above and below the gravity conveyor, spaced approx. 0.5 m apart. The antennas were connected to a reader, which was activated (its activation allows it to initiate the sending and receiving of RF waves, and thus “question” the inlay inside each box) by a photosensor which detected the presence of a bundle upstream of the antenna portal.

Only for the purpose of validating the present invention, the inlays used during the pilot trial all had a unique ID number, which allowed the differentiation of each inlay from another when a bundle was read at the portal. This is not required in an actual “real life” application. During the testing, this allowed the system to alert the operator in the event of a bundle passing through the portal with fewer than 20 readable RFID inlays within it. A red indicator was lit for bundles failing this test, while a green one was lit for bundles displaying a 100% read rate. Each bundle which activated the red indicator was put aside on a re-work pile, and was manually inspected at the end of the run using a handheld scanner to find the defective inlay(s) within the bundle.

The reader data was collected in an Access database located on the PC running the Domino reader application, and the link with the plant's production control system was done by hand for the duration of the trial.

The range of speed under evaluation was from 5000 to 18000 boxes/hour; historical speed data being unavailable, it was estimated that 90% of the run was performed at speeds between 6000 and 10000 boxes/hour.

### Example 2

### Box Performance on Case Packer

The first batch of boxes produced in example 1 were run through a case packing line. A total of 240 boxes were filled in 40 minutes of run time on the case packer (equivalent to 360 cases/hour, which is the optimal throughput of this line). No case quality-related issues were reported. The glueability of the boxes was flawless, as was the integrity of the box joint within which the RFID inlay is positioned. No case packer-related issues were reported that could have negatively affected the production rate.

### Example 3

### Encoding, Testing and Read Rates

Testing on the ability to encode, lock and verify information onto the RFID inlays positioned within the corrugated boxes filled with product was undertaken. Other than varying the conveyor speed at which these operations were performed, the boxes were split into 4 subgroups which were then subjected to different environmental conditions: a batch was stored inside under “normal” conditions, a batch was stored inside after having been soaked in water, a batch was stored in a dry location outside (24 hours under freezing conditions), and a batch was stored outside after having been soaked in water (that batch froze overnight).

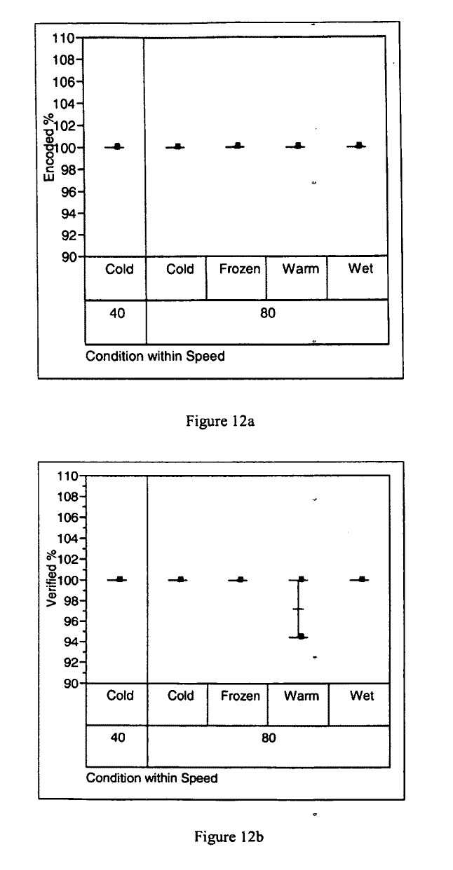

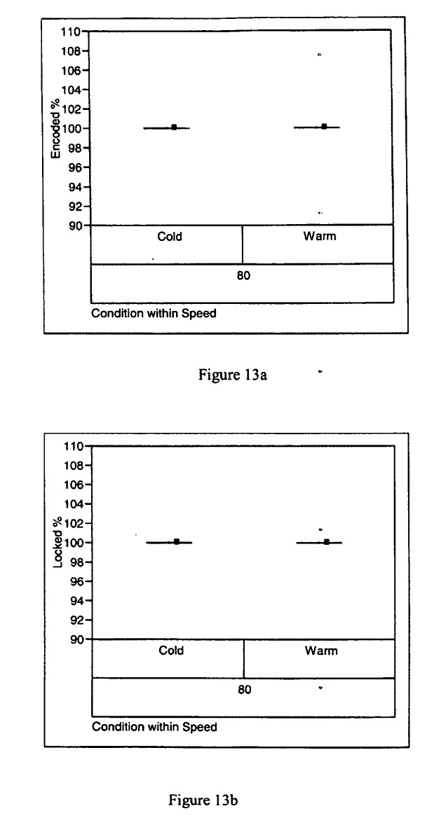

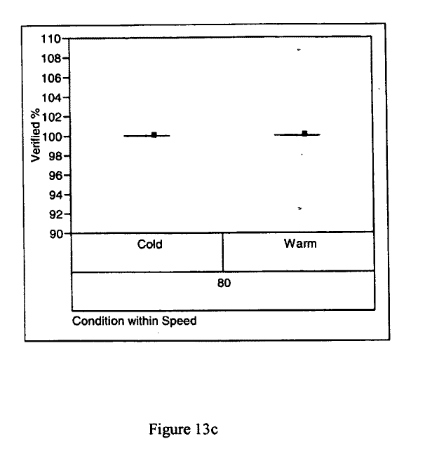

For both the encode & verify and the encode, lock and verify runs (performed at 40 and 80 fpm, a range of speeds that is typical of industrial case packers), no statistical difference was observed between the various treatments inflicted to the cases. In all cases, a 100% rate could be obtained for each attribute (encoding, locking, verifying). In other words, it was just as easy to encode, lock and verify boxes that had been stored inside in dry conditions as those that had been stored in wet conditions outside. This indicates that the box structure, and more specifically the adhesive which covers the inlay, is effective at protecting the RFID inlay from environmental conditions which would had been adverse to its performance had it been positioned on the surface of the box. The results for these runs are illustrated in FIGS. 12-13. FIG. 12a shows the variability chart for encode % and FIG. 12b shows the variability chart for verify runs at 40 and 80 fpni. The variability chart for encode, lock & verify Runs at 80 fpm are shown in FIGS. 13a-c.

The read rates were also evaluated for the tags placed within the corrugated structures, a characteristic that is not subjected to an accepted standard within the RFID community, but which is nonetheless indicative of both the inlay quality and the RF interference present between it and the RF antennas trying to interrogate it. Because of the aforementioned successful results obtained on the lower speed conveyor, it was decided to study the performance of the inlays under more demanding conditions, i.e. on a high-speed conveyor.

The read rates of the RFID-enabled cases were thus evaluated at 300 and 600 fpm, and using the same cold, frozen, wet and warm batches of cases as for the encode, lock and verify test runs. As stated above, packaging media are subjected to a wide range of external stresses that can impact the integrity and function of the RFID inlays. Therefore, the present invention was tested by subjecting the packaging media containing RFID inlays to a wide variety of external stresses, including temperature changes and varying moisture conditions to ascertain if the RFID inlays were still able to function. Since there exist no standard nor industry guideline as to the read rates that are to be expected from UHF RFID inlays, the performance was benchmarked with that of past customers, who obtained rates in the range of 10-70 reads/sec. As evidenced by the following figures, the results obtained fell within that range (over all the test scenarios, an average of 42 reads/sec was obtained), which would indicate that the embedded inlays could be read just as easily as those located on the surface of past customers' boxes.

The results discussed above were obtained using an RF attenuation on the reader/antennas combo set at 75 dB, which can be considered “normal” as it is commonly encountered in production environments. Several repeat runs were performed using a drastically lower RF attenuation, 40 dB however, no significant change in performance was observed.

### Example 4

### Effect of Corrugated Adhesive on Inlay Readability

The first series of tests was aimed at evaluating the magnitude of the effect of the corrugated adhesive, also referred to herein as “glue”, on the RFID inlay readability. To do so, bundles of 25 boxes, both with and without glue, were passed through an RFID portal, which consisted in a pair of circularly polarized antennas installed 1.25 ft apart on either side of a conveyor, one above and one below.

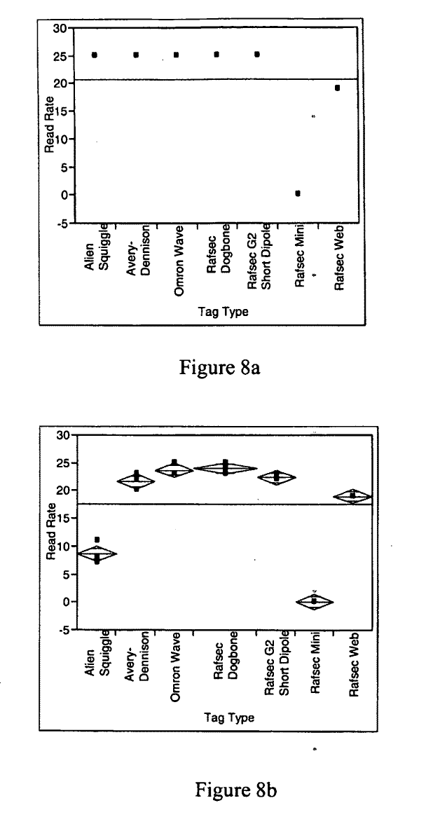

The read rate was defined as the number of different RFID inlays detected (out of a total of 25) as the bundle passed through the RF field. Seven RFID inlay designs were tested, both glued and unglued. Overall, there was no statistical difference in the read rates obtained with glued and unglued boxes, as shown in FIGS. 8A and 8B. FIG. 8A shows analysis of read rate by tag type for glued tags and FIG. 8B shows analysis of read rate by tag type for not glued tags. Moreover, numerous inlay designs displayed 100% read rates in the presence of glue, further validating the hypothesis stating that the adhesive does not adversely affect the inlay readability.

### Example 5

### Effects of Antenna Type & Glue Moisture Content on Inlay Readability

The second series of tests was aimed at evaluating the magnitude of the effects of the type of polarization used in the antennas, and of the corrugated adhesive moisture content on the RFID inlay readability. To do so, bundles of 25 boxes, both with freshly applied glue, referred to as “wet”, and glue applied 24 hours prior to the-test runs, referred to as “dry”, were passed through an RFID portal, which consisted in a pair of antennas installed 1.25 ft apart on either side of a conveyor, one above and one below. Half of the test runs were performed using circularly polarized antennas, and half with linearly polarized antennas.

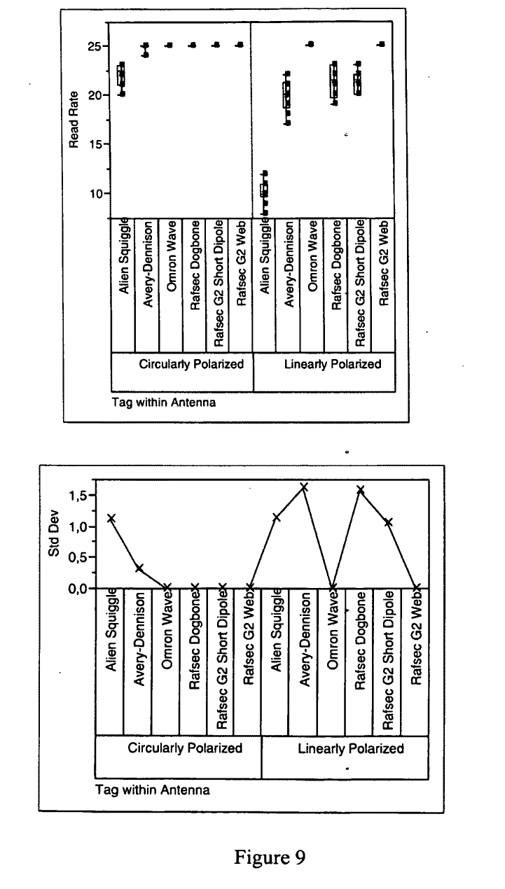

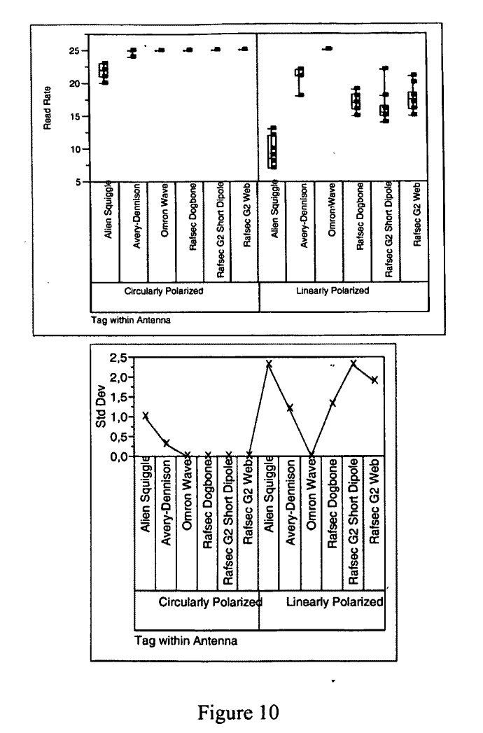

The read rate was defined as the number of different RFID inlays detected (out of a total of 25) as the bundle passed through the RF field. Six RFID inlay designs were tested. Overall, there was no statistical difference in the read rates obtained with wet and dry glue. Two different types of antennas were tested, circularly and linearly polarized antennas, and both worked. FIG. 9 shows the variability chart for dry glue read rates (circularly & linearly polarized antennas) and FIG. 10 shows the variability chart for wet glue read rates (circularly & linearly polarized antennas).

### Example 6

### Box Integrity Testing (Top-To-Bottom Compression Strength Testing)

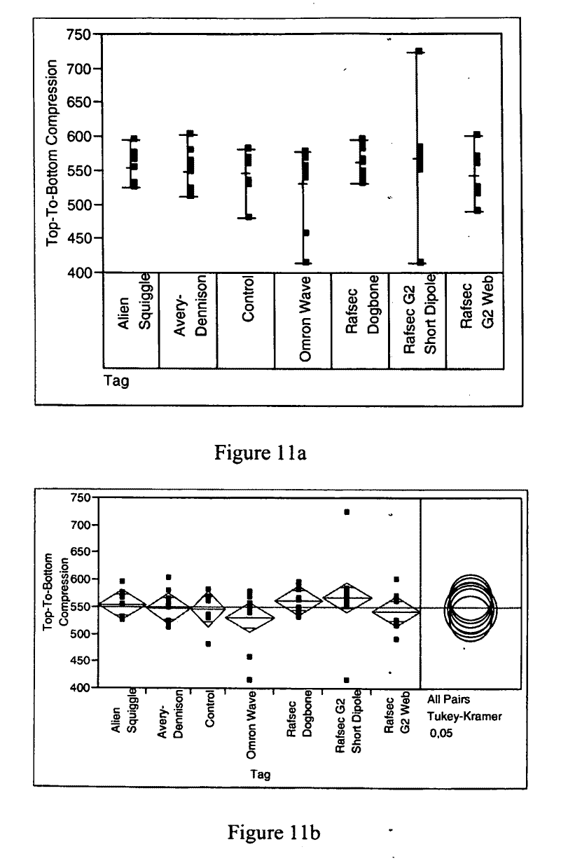

The integrity of the boxes to which the RFID inlay was attached were also verified. The integrity of the RFID inlay-containing box structure was tested using a compression table in which an axial load was applied to the boxes until buckling failure occurred. The top-to-bottom compression strength characteristics of boxes containing 6 types of RFID inlays were compared to those of boxes that did not contain RFID inlays within their structure, referred to as the “control” specimen. The results are illustrated in FIGS. 11a and b, and clearly demonstrate the absence of a statistically significant difference between the strength of boxes with RFID inlays and control boxes. FIG. 11 a shows a variability chart for Top-To-Bottom compression strength and FIG. 11b shows analysis of means of Top-To-Bottom compression strength by tag type.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

Any publications, patents and patent applications referred to herein are incorporated by reference in their entirety to the same extent as if each individual publication, patent or patent application was specifically and individually indicated to be incorporated by reference in its entirety.

1. An RFID enabled packaging media comprising:
a plurality of panels configured to form the packaging media;
at least one joint formed from at least two overlapping panels;
at least one RFID inlay located within the joint on the surface of at least one of the overlapping panels such that the RFID inlay is positioned between the overlapping panels when the joint is formed; and
an adhesive layer, for adhering the overlapping panels of the at least one joint, located between the overlapping panels and on at least one surface of the RFID inlay.

2. The RFID enabled packaging media according to claim 1, wherein the RFID inlay comprises a lower adhesive surface positioned adjacent the surface of at least one of the overlapping panels and an upper surface for receiving the adhesive thereupon.

3. The RFID enabled packaging media according to claim 2, wherein the adhesive layer substantially covers the upper surface of the RFID inlay.

4. The RFID enabled packaging media according to claim 2, wherein the adhesive layer completely covers the upper surface of the RFID inlay when the joint is formed.

5. The RFID enabled packaging media according to claim 1, wherein the adhesive in the adhesive layer is selected from the group consisting of a coldset adhesive, a hotmelt adhesive and a starch based additive.

6. The RFID enabled packaging media according to claim 1, wherein the adhesive in the adhesive layer is a coldset adhesive.

7. The RFID enabled container blank according to claim 6, wherein the coldset adhesive is selected from the group consisting of water-based emulsions of polyvinyl acetate, polyurethane, caseine, starch, latex and acrylic polymers and copolymers.

8. The RFID enabled packaging media according to claim 7, wherein the coldset adhesive is selected from the group consisting of water-based emulsions of polyvinyl acetate, vinyl acetate ethylene and vinyl acetate acrylate.

9. The RFID enabled packaging media according to claim 5, wherein the hotmelt adhesive is selected from the group consisting of emulsions of ethylene vinyl acetate and styrene.

10. The RFID enabled packaging media according to claim 1, wherein the packaging media comprises a series of joints formed by overlapping panels.

11. The RFID enabled packaging media according to claim 10, further comprising a plurality of RFID inlays each located in one of the series of joints.

12. The RFID enabled packaging media according to claim 1, wherein the packaging media is selected from the group consisting of folding boxboard, corrugated containerboard, envelopes and flexible packaging.

13. A method of manufacturing an RFID enabled packaging media comprising the steps of:
(i) forming a flat packing media blank having a plurality of panels configured to form a packing media when the blank is assembled;
(ii) attaching an RFID inlay to at least one of the panels;
(iii) applying an adhesive layer to at least one of the panel comprising the RFID inlay and an adjacent panel with which the at least one panel is operable to form a joint with; and
(iii) forming a joint with the panel comprising the RFID inlay and the at least one other panel, wherein the RFID inlay is located between the panels adjacent the adhesive layer and the adhesive layer substantially covers the RFID inlay.

14. The method according to claim 13, wherein the adhesive layer is applied to both the panel comprising the RFID inlay and the adjacent panel with which the panel comprising the RFID inlay is operable to form a joint.

15. The method according to claim 13, wherein the adhesive in the adhesive layer is selected from the group consisting of a coldset adhesive, a hotmelt adhesive and a starch based additive.

16. A container formed from the container blank defined in claim 1.

17. The container according to claim 16, wherein the joints free of an RFID inlay are formed using an adhesive other than the adhesive used in the at least one joint comprising the RFID inlay.

18. A method for installing and verifying an RFID inlay in a packaging media comprising the steps of (i) providing at least one packaging media blank having a plurality of panels configured to form a packing media when the blank is assembled;
(ii) providing at least one RFID inlay at a position operable to allow placement of the RFID inlay on at least one of the plurality of panels;
(iii) confirming the operability of the RFID inlay; (iv) applying the RFID inlay to at least one of the plurality of panels;
(v) applying adhesive to the surface of the RFID inlay;
(vi) forming a joint between the panel to which the RFID inlay is attached and an adjacent panel in order to form a partially assembled packaging media; and
(vii) confirming the operability of the RFID inlay.

19. The method according to claim 18, further comprising a step of placing an indicating means on the packaging media if the confirmation step indicates a non-operable RFID inlay.

20. The method according to claim 19, wherein the indicating means is a UV indicia to show a non-operable RFID inlay.

21. The method according to claim 18, wherein the adhesive in the adhesive layer is selected from the group consisting of a coldset adhesive, a hotmelt adhesive and a starch based additive.

22. The method according to claim 18, further comprising a step of removing the packaging media if the confirmation step of the operability of the RFID inlay indicates a non-operable inlay.

23. The method according to claim 18, wherein the amount of applied adhesive is sufficient to cover the surface of the RFID inlay when the joint is formed.

24. The method according to claim 18, wherein the amount of applied adhesive is sufficient to cover the surface of the RFID inlay prior to the formation of the joint.

25. A packaging media formed from the method of claim 18.

26. A packaging media formed from the method of claim 13.

2. An RFID enabled packaging media comprising:
a plurality of panels configured to form the packaging media;
at least one RFID joint formed from at least two overlapping panels and a plurality of non-RFID joints formed from at least two overlapping panels;
at least one RFID inlay located within the RFID joint on the surface of at least one of the overlapping panels that form the RFID joint such that the RFID inlay is positioned between the overlapping panels when the RFID joint is formed;
a first adhesive layer, for adhering the overlapping panels of the at least one RFID joint, located between the overlapping panels and on at least one surface of the RFID inlay; and
a second adhesive layer, for adhering the overlapping panels of the non-RFID joints.

2. The packaging media according to claim 26, wherein the first and the second adhesive layers are different.

2. The packaging media according to claim 26, wherein the first adhesive layer is selected from the group consisting of a coldset adhesive, a hotmelt adhesive and a starch based additive.
